(19) United States
(12) Patent Application Publication
(10) Pub. No.: US 2023/0229023 A1
(43) Pub. Date: Jul. 20, 2023

(54) SUNGLASSES FOR SPOTTING SHARK TEETH

(71) Applicants: Andrew Sinclair, Scott Depot, WV (US); Jospeh J. Sinclair, Scott Depot, WV (US)

(72) Inventors: Andrew Sinclair, Scott Depot, WV (US); Jospeh J. Sinclair, Scott Depot, WV (US)

(21) Appl. No.: 18/097,231

(22) Filed: Jan. 14, 2023

Related U.S. Application Data
(60) Provisional application No. 63/299,647, filed on Jan. 14, 2022.

(51) Int. Cl. G02C 7/10

(52) U.S. Cl. CPC G02C 7/104; G02C 7/108

(57) ABSTRACT

The present invention consists of a set of sunglasses used for locating shark teeth on a beach. The invention takes advantage of the way the human brain generates images in order to make shark teeth stand out on the sand. It does so by blocking out specific wavelengths of light that help to accentuate color differences between the teeth and the underlying beach surface. Shark teeth undergo a change of color after falling out that causes them to be differentiable in shade from sand or sediment. By selectively filtering corresponding shades of light, the present invention causes the teeth to stand out as spots on the sand, significantly increasing the ease of spotting and collecting them. When the wavelengths of light reaching the eye are filtered, the shark teeth ultimately stand out as stark dark areas on the beach.

### BACKGROUND OF THE INVENTION

In order to prevent the sun from causing irritation to sensitive eyes, many beach goers elect to wear sunglasses. Sunglasses are tinted eyeglasses designed to filter out or reflect harmful ultraviolet rays from the sun and dim visible light to a comfortable level. However, many sunglasses have the unfortunate consequence of preventing beach combers from being able to easily spot things they are hunting for by virtue of blocking out light. One of the most popular targets for beach combers are shark teeth, which slowly change color from the white found in the mouths of sharks to the black found in fossilized shark teeth. This process is called permineralization. It occurs over time and the teeth are embedded in sand and minerals like silica and calcite are deposited over the open pores present in the teeth.

### BRIEF SUMMARY OF THE INVENTION

The present invention allows beachgoers to search for shark teeth while simultaneously protecting their eyes from the sun. A conventional sunglass frame is fitted with a novel lens that is selectively permeable to the shades of light reflected by sand beds where shark teeth can be found. While the lens blocks a vast majority of the sun's bright light from reaching the eye, roughly twice the background level of gray and 8 times the background level of orange are permitted to pass through the lens, which makes beaches appear brighter than the rest of the field of the user's vision. The ultimate effect is that the light being reflected from the shark teeth meets the eye at a significantly lower intensity that other wavelengths of light, and in effect makes the tooth appear as a black spot on the otherwise brightened surface of the beach.

### BRIEF DESCRIPTION OF THE DRAWINGS

FIG. 1 shows the frame and lens of the invention.

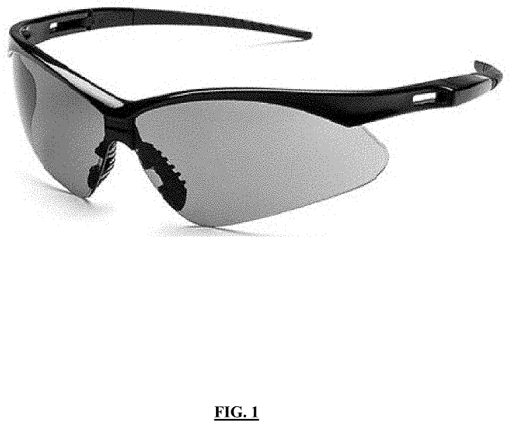

FIG. 2 shows the tinting specifications of the lens.

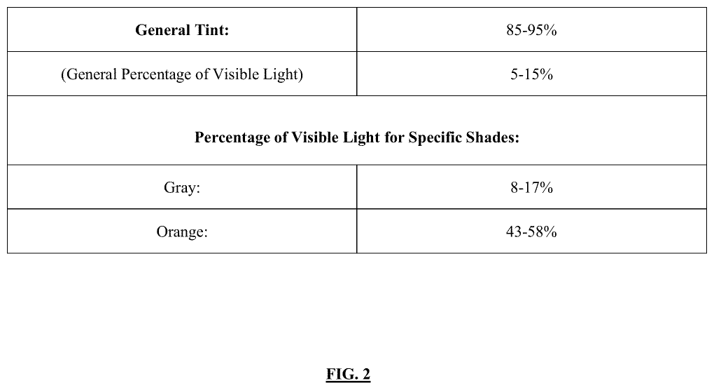

### DETAILED DESCRIPTION

The general concept of sunglasses, that being protective eyewear designed to filter the dim the light of the sun to a manageable level, has existed for centuries. The earliest known examples were pieces of smoked quartz fitted to an eyeglass frame. Since then, sunglasses have benefitted from other advances in technology. Some have been developed to block polarized light and reduce glare. Others have been formulated to stop ultraviolet light. The core concepts present in the invention as they relate to well-known sunglasses technology are the structure of the frames and their general pairing with a tinted lens. The frames consist of a means of holding the lens in front of the eyes, as well as a means of affixing the lens to the head such that they can be easily worn. More often than not, this takes the form of “arms”, which protrude from either side of the frame and sit on top of the ears as well as the bridge of the nose. Other embodiments include a strap to fix the lens in front of the user's eyes. Many frames include some type of cushioning for the nose, the ears, or both.

In the present invention, the lens affixed to the frames embodies a unique formulated blend of tinting that corresponds to sand beds on which users search for shark teeth. Shark teeth are a valuable find for any beach comber, who is generally more likely to prefer finding older shark teeth in the sand to seeking them in the mouth of a live shark. Luckily, most sharks lose teeth very frequently and grow them back quickly as part of their life cycle, so shark teeth can be found in the sand of most beaches in relatively large numbers. Unfortunately, shark teeth may be smaller than shells and other beach debris, making sifting for them extremely difficult. They are also less common than shells, meaning that large amounts of sand would need to be sifted to find even a small handful of shark teeth spread out across a beach. The unique nature of the lens makes them easy to spot due to the colors attained through and during the permineralization process and the difference between those colors and the beach itself.

The lens present in the invention is darkly tinted such that it blocks out most light. This provides protection from the sun, but also is a critical element in what allows the teeth to effectively shine. While roughly 85-95% light across most wavelengths is blocked by the lens, shades of gray light are permitted to pass through at roughly twice the rate of other light and shades of orange are permitted to pass through at around five times the rate of other light. This gray-orange spectrum correlates to the shades of beach sediment and silica based shells, leaving minerals being deposited on the porous calcium phosphate present in shark teeth to appear as dark spots on a brighter background. As a result, teeth found in the sand are visible at a significantly greater rate due to their lower light intensity than the background wavelengths of light, making them stand out to the user. By focusing the eye on just the colors present in the beach, the invention allows the user to locate shark teeth by quickly scanning a beach and looking for darker spots indicative of the teeth present on the sand.

Beachcombers have been seeking these teeth for centuries with or without sunglasses. Shark teeth are rarer and harder to locate than shells and can be found in coastal gift shops all over the country. People purchase them in jewelry or jars as souvenirs frequently, but a shark tooth has a deeper sentimental value when it is found in the sand by the person who brings it home. The present invention allows beachcombers to locate shark teeth quickly and easily without being forced to sift methodically through the beach. Instead, by using the disclosed sunglasses to locate the teeth where they are deposited on the beach by isolating their unique coloration, these small disparate treasures can be spotted gleaming in the sands and plucked from their hiding places with minimal effort.

1. An apparatus for locating shark teeth comprising:
a frame that is designed to rest on a user's face; and
a lens that is specially suited for spotting shark teeth.

2. The apparatus of claim 1 in which the lens consists of a tinted piece of transparent material that blocks wavelengths of light that correspond with teeth.

3. The apparatus of claim 2 where the lens is tinted in the gray and orange tones of sand.

4. Sunglasses specifically suited for finding sharks teeth consisting of a frame and an orange and gray tinted lens that effectively blocks the color of shark teeth.
